(19) United States
(12) Patent Application Publication
(10) Pub. No.: US 2017/0106622 A1
(43) Pub. Date: Apr. 20, 2017

(54) THERMOREGULATORY IMPACT RESISTANT MATERIAL

(71) Applicant: Robert J. Bonin, Bristol, VA (US)

(72) Inventor: Robert J. Bonin, Bristol, VA (US)

(21) Appl. No.: 14/883,201

(22) Filed: Oct. 14, 2015

(51) Int. Cl. B32B 5/02; A41D 1/06; A41B 1/08; A41B 9/00; A41D 13/00; A41D 31/00; A41D 3/00; A41D 19/01; A42B 1/04; A41D 20/00; A41D 19/015; B32B 5/26; A41D 1/04

(52) U.S. Cl. CPC B32B 5/028; B32B 5/026; B32B 5/024; B32B 5/26; A41D 1/06; A41B 1/08; A41B 9/00; A41D 13/0015; A41D 1/04; A41D 3/00; A41D 19/01; A42B 1/046; A41D 20/00; A41D 19/01529; A41D 31/0038; A41D 31/0061; B32B 2307/56; B32B 2307/724; B32B 2307/206; B32B 2437/00; B32B 2307/3065; A41D 2500/20

(57) ABSTRACT

The present invention relates to a protective material which is used in a wearable article to enhance thermal regulation of the user, provide protection to the user by means of pressure and energy absorption, and acts as a platform for technologies (such as sensors) that increase performance and function when worn by the user. The protective, thermoregulatory impact resistant material includes a mesh material which has layers of woven yarn connected together between layers, and having an overall pattern. The mesh material is knitted as a layered three-dimensional fabric, where the layers are interconnected by spacer yarn. The mesh material provides both evaporative cooling, and acts as an insulating barrier, and its properties can be controlled by an openness, thickness, or tightness of the weave of the yarn, or a distance between the layers. The mesh material can be worn under protective clothing and equipment.

### BACKGROUND OF THE INVENTION

1. Field of the Invention

The present invention relates to a thermoregulatory impact resistant material which is used in a wearable article. The wearable article enhances thermal regulation of the user, provides protection to the user by means of pressure and energy absorption, and acts as a platform for technologies that increase user performance and function.

2. Description of the Related Art

The evolution of clothing and equipment designed to protect individuals from hostile environments, as well as to allow individuals to perform at high levels in athletic arenas, have solved certain problems while creating new ones. Protecting the body from environmental or occupational hazards means the individual must carry additional physical weight and necessitates encapsulating the body, or parts thereof, with appropriate clothing or equipment. In terms of human performance, this directly translates to the body carrying a heavier physical load while simultaneously compromising its thermoregulatory system. In addition, while the protective clothing and equipment may stop specific injurious events to the body, they may still not provide sufficient energy absorption to prevent some level of injury from occurring.

In an effort to increase the bounds of human performance, a number of fabrics have been developed with the goal of enhancing thermoregulation of the body. Most of these products are aimed at assisting the body in dissipating heat by moving perspiration off the skin through the use of fabrics with different fiber content or topical treatments. While fabric content and topical treatments may vary widely, each of these products is similar in that they allow perspiration to evaporate on what is essentially a flat surface lying directly on the skin. This means that the exposed surface area of one square inch of fabric is essentially the very same area as the skin directly beneath it. This “one dimensional” aspect of the fabric inherently limits these products in their ability to render efficient evaporative cooling.

Thus, a material used in a wearable article, which can provide impact resistance, which can improve the effectiveness of thermoregulation of the user, which can essentially address the myriad of problems faced by individuals who wear protective clothing or equipment, and which can also provide a platform solution for technologies that need to be worn by an individual, is desired.

### SUMMARY OF THE INVENTION

The present invention relates to a protective, thermoregulatory impact resistant material which is used in a wearable article. The wearable article enhances thermal regulation of the user, provides protection to the user by means of pressure and energy absorption, and acts as a platform for technologies that increase performance and function when worn by the user.

In one embodiment, the protective material includes a mesh material including a plurality of layers of woven yarn, the plurality of layers being connected by a spacer yarn; and a base material connected to the mesh material on one side of said the material, and connected to one of the plurality of layers; wherein the mesh material is provided in a three-dimensional form as a wearable article, which provides thermal regulation, and resistance to impact and pressure for a user.

In one embodiment, the mesh material is a warp knitted double-faced fabric.

In one embodiment, the yarn is knitted and includes one of nylon, polyester, rayon, modacrylic, PPS (polyphenylene sulfide), or aramids, or any combination thereof.

In one embodiment, the yarn is one of fire resistant, hydrophobic, hydrophilic, or a combination thereof.

In one embodiment, the plurality of layers has an overall pattern.

In one embodiment, the spacer yarn is one of monofilament yarn or multifilament yarn.

In one embodiment, the knitted yarn of the mesh material is woven to provide properties of at least one of compression or impact resistance, recovery, breathability, moisture transfer capabilities, or thermal regulation; and the properties of the mesh material can be varied or controlled by at least one of an openness, thickness, or tightness of the yarn, or a distance between the plurality of layers.

In one embodiment, the mesh material is treated with chemicals to provide at least one of fire resistance, antimicrobial properties, antistatic properties, or abrasion resistance, or hydrophobic or hydrophilic properties.

In one embodiment, the base material is circular or tubular knitted.

In one embodiment, the mesh material is shaped as a panel.

In one embodiment, the wearable article is at least one of a body suit, shirt, top, shorts, pants, undergarment, sports wear, headwear, protective gear, outerwear, or accessory.

In one embodiment, a weight of the base material is approximately 3 to 6 ounces per yard for the wearable article designed for cooling purposes, and from 8 to 12 ounces for the wearable article designed for insulator purposes.

In one embodiment, the mesh material one of completely covers the base material, or does not completely cover the base material.

In one embodiment, the base material is connected to one of the plurality of layers of the mesh material on one side of the mesh material at an outer perimeter thereof using a binding material, the binding material which connects to the base material using an attachment mechanism.

In one embodiment, the base material is made of manmade or natural fibers and yarns including at least one of cotton, wool, nylon, polyester, rayon, modacrylic, aramid, or a blend thereof.

In one embodiment, the base material has properties including at least one of moisture vapor transfer, clo value, stretch, modularity, antimicrobial properties, antistatic properties, fire resistance, sun protective factor (SPF), or abrasion resistance.

In one embodiment, the base material is a synthetic material including elastane.

In one embodiment, the mesh material is disposed in the wearable article and worn in conjunction with protective clothing and equipment.

In one embodiment, at least one of cold or heat chemical or electric packs, or plates or pads, are attached to the mesh material to increase heating or cooling properties; and the plates or pads include at least one of plastics, synthetics, metals or ceramics.

In one embodiment, the mesh material is a base platform for technologies which include a plurality of devices, said plurality of devices including sensors, antennas, wires, or tubes, used in a plurality of applications.

In one embodiment, the base material and the mesh material are of any color.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a perspective view of a thermoregulatory impact resistant material used in one or more exemplary wearable articles shown on a user, according to one embodiment consistent with the present invention.

FIG. 2 is a perspective view of the thermoregulatory impact resistant material of FIG. 1, according to one embodiment consistent with the present invention.

FIG. 3 is a front view of the thermoregulatory impact resistant material of FIG. 1, according to one embodiment consistent with the present invention.

FIG. 4 is a cross-sectional view of the thermoregulatory impact resistant material of FIG. 3, taken along the line 4-4, according to one embodiment consistent with the present invention.

### DESCRIPTION OF THE INVENTION

The present invention relates to a protective, thermoregulatory impact resistant material which is used in a wearable article. The wearable article enhances thermal regulation of the user, provides protection to the user by means of pressure and energy absorption, and acts as a platform for technologies that increase performance and function when worn by the user.

Thermoregulation (temperature control) is part of a homeostatic mechanism that keeps an organism at optimum operating temperature. In humans, the average internal temperature is 37.0° C. (98.6° F.). A human being can only tolerate a variation of around 4° C. in internal body temperature without physical and mental performances being impaired. Further, research has shown an optimal office temperature between 21° C. to 23° C. provides the best temperature for maximum office worker productivity. These same studies demonstrate that just a few degrees difference can have a 5% or more degradation in productivity. Thus, as temperatures increase or decrease, humans are less productive.

The main source of heat in the body is called “metabolic heat”, and it is generated within the body by the biochemical processes that keep us alive and by the energy we use in physical activity. Most of the heat is conducted in the blood stream to the skin where it is released into the environment.

The human body has four processes for thermoregulation: convection, conduction, radiation and evaporation. So long as the skin temperature is greater than the surroundings, the body can lose heat by radiation and conduction. In this case the heart rate increases to pump more blood through outer body parts and skin so that excess heat is lost to the environment. If however, the temperature of the surrounding environment is greater than that of the skin, the body actually gains heat by radiation and conduction. In such conditions, the only means by which the body can rid itself of excess heat is by evaporation.

As the heat burden of the human body increases, so do its effects which include: a decrease in situational awareness, loss of concentration and ability to do mental tasks, and inability to do physical labor. If the body is unable to maintain a normal temperature and it increases significantly above normal, a condition known as hyperthermia occurs. Hyperthermia is an elevated body temperature due to failed thermoregulation that occurs when a body produces and/or absorbs more heat than it dissipates. Extreme temperature elevation is a medical emergency requiring immediate treatment to prevent disability or death.

Most clothing and accessories (shirts, tanks, tops, tights, shorts, headbands, etc.) which are designed for participating in aerobic sports, are currently manufactured from fabrics made from “wicking” fibers, or fabric topically treated with chemicals to assist the body in wicking perspiration off the skin. The fabric then holds the moisture until it is evaporated into the air. These present day products all face a similar limitation in their approach to evaporative cooling, because the area of the garment where evaporation occurs is almost the same size as the skin area it covers. This means that the rate of evaporation from the fabric is going to be, at best, the same as if the skin had no covering and was directly exposed to the very same environment.

The present invention is designed to replace these types of limited thermoregulatory garments, and is directed to a protective, thermoregulatory impact resistant material used in a wearable article, which can improve the effectiveness of thermoregulation of the user, which can provide impact resistance, and which can also provide a platform solution for technologies that need to be worn by an individual.

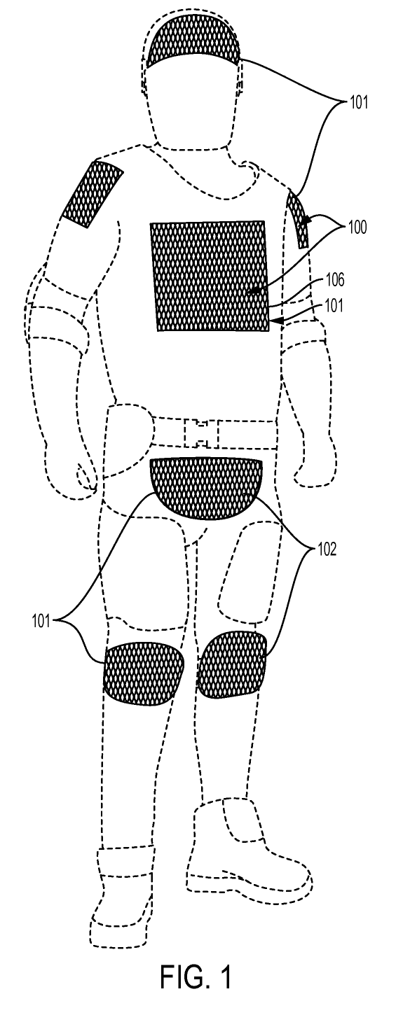

The thermoregulatory impact resistant material 100 of the present invention is shown in FIG. 1, and can form any embodiment of wearable article 101, including, but not limited to: body suit (short sleeved and long sleeved, and short or long lengths); shirt (both short and long sleeved, of any neck type); tank top; shorts; pants (including tights); undergarment (i.e., sports bra, long johns); sports wear (shorts, tops, unitards); headwear (i.e., balaclava, cap, headband); protective gear (throat guard, shin guards, upper arm and forearm protectors, chest protectors, helmet liners); outerwear (i.e., jackets, vests, coats); and accessories (gloves/mittens), etc.

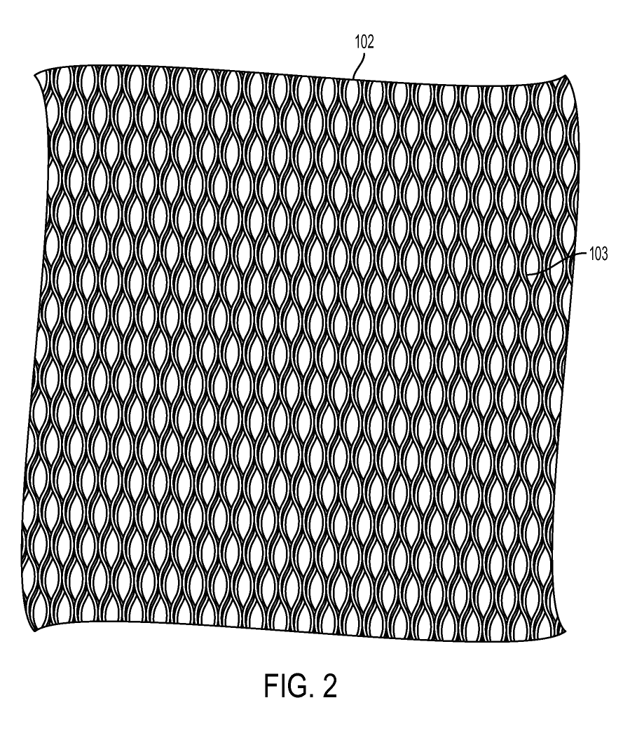

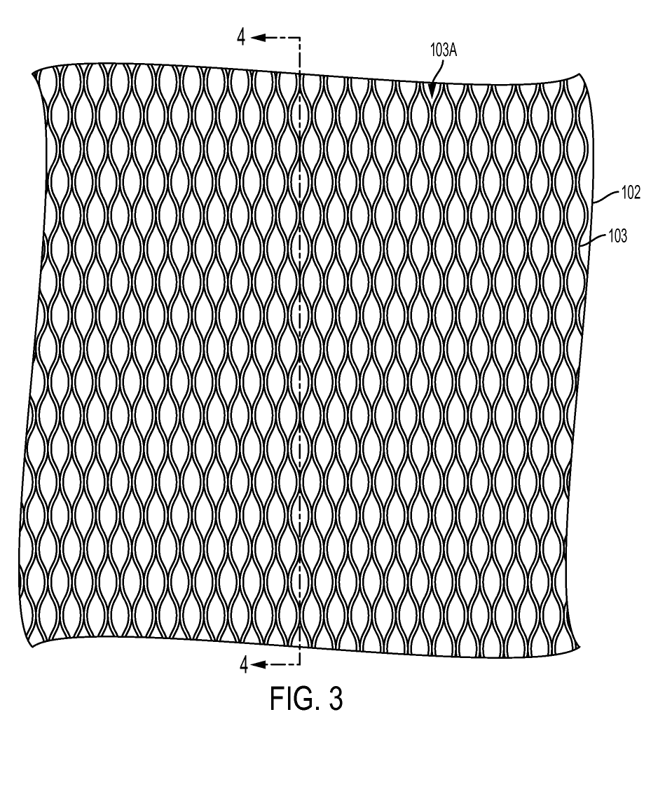

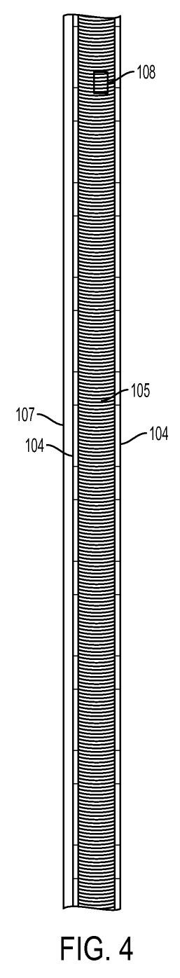

In one embodiment, the thermoregulatory impact resistant material 100 of the present invention is comprised of a mesh material 102 (see FIGS. 2-3) which has layers of yarns 103 connected together between layers 104 (see FIG. 4), and having an overall pattern 103A (i.e., diamond or square pattern or other shape). In one embodiment, the mesh material 102 is formed from a warp knitted double-faced fabric or yarn 103 having two faces or layers 104 in a three-dimensional fabric, where both faces or layers 104 are interconnected by spacer or pile yarns 105. In one embodiment, the two faces or layers 104 of the mesh material 102 are exactly the same in design and/or yarn content, and in another embodiment, the two faces or layers 104 are different in design and/or yarn content.

In one embodiment, the mesh material 102 is completely stable and in another embodiment, it is knitted such that it provides stretch to the material in one or more directions.

The spacer or pile yarn 105 connecting the two layers 104 is normally monofilament yarn, but could be multifilament yarn as desired. Further, the mesh material 102 could comprise multiple layers 104 interconnected between layers 104 by spacer or pile yarn 105.

The unique characteristics of the mesh material 102 or fabric provide it with compression or impact resistance, recovery, breathability, moisture transfer capabilities, thermal regulation, and other features. The mesh material 102 layers 104, density, compression resistance, and recovery, etc., can all be varied and controlled in the knitting process (i.e., openness, tightness of the weave, thickness of the yarn, etc.) to achieve specific performance standards.

The range of fibers and yarns that may be used to knit the fabric of the mesh material 102 includes, but is not limited to: nylon, polyester, rayon, modacrylic, PPS (polyphenylene sulfide), and aramids, or combinations thereof, among others. In one embodiment, the yarn 103 used for the mesh material 102 has a high degree of stretch and moisture wicking ability. However, in accordance with the requirements of the user, hydrophobic rather than hydrophilic yarn may be used, or a combination thereof. Further, the mesh material 102 of the present invention may have specific characteristics, and may be treated with chemicals, to include properties such as: fire resistance, antimicrobial properties, antistatic properties, or abrasion resistance, among others.

In one embodiment, the mesh material 102 is formed as a panel 106, which is used as the thermoregulatory impact resistant material 100 in a wearable article 101.

In one embodiment, the mesh material 102 is provided in a wearable article 101, where the mesh material 102 is attached on one side (i.e., at one layer 104) to a base material 107 or base layer fabric (see FIG. 4). In one embodiment, the mesh material 102 does not completely cover the base layer fabric 107; however, in other embodiments, it does completely cover the base layer fabric 107. In one embodiment, the mesh material 102 is generally attached to the base layer fabric 107 by sewing the mesh material 102 along an outer perimeter edge which has a binding material (not shown) sewn thereon. This insures that the exposed edge of the mesh material 102 does not create discomfort to the wearer. The mesh material 102 may be attached to the base layer fabric 107 by other mechanisms or means, other than sewing, such as: sonic welding, use of adhesives, and other mechanical attachment methods, etc.

In one embodiment, the base layer fabric 107 is made of man-made or natural fibers and yarns including, but not limited to: cotton, wool, nylon, polyester, rayon, modacrylic, aramid or any blend thereof. In one embodiment, the base layer fabric 107 is circular or tubular knitted.

In one embodiment, the base layer fabric 107 may have one or more of a number of desired specifications (can be treated with chemicals, for example), including, but not limited to: moisture vapor transfer, clo value (measures thermal insulation of clothing), stretch, modularity, antimicrobial properties, antistatic properties, fire resistance, sun protective factor (SPF), or abrasion resistance, etc. A preferred fiber or yarn used in the construction of the base layer fabric 107 is spandex or elastane, such as Lycra®, due to the fact that stretch and compression are important parts of making the thermoregulatory impact resistant material 100 of the present invention, fit and perform properly.

In one embodiment, the weight of the base layer fabric 107 would be approximately 3 to 6 ounces per yard for wearable articles 101 designed to be used for cooling purposes, and from 8 to 12 ounces for those designed to for insulator purposes (i.e., protection from cold).

The base layer fabric 107 with the mesh material 102 attached thereto as a wearable article 101, is a “next to skin” fabric which has direct contact with the skin. In one embodiment, the thermoregulatory impact resistant material 100 of the present invention is constructed using a single base layer fabric 107, but the present invention may also include more than one base layer fabric 107.

The present invention solves the limitations of current garments by offering a three-dimensional surface area for evaporative cooling. One square inch of the three dimensional mesh material 102 of the present invention equals several times the surface area of the skin beneath it. Thus, the amount of evaporative cooling that can occur with the thermoregulatory impact resistant material 100 of the present invention is directly related to the amount of surface area exposed to the outside environment.

The present invention's evaporative cooling properties can be increased by both varying the thickness and the openness of weave of the yarn 103 in the mesh material 102. Further, as noted above, the evaporative cooling properties of the present invention can further be increased by knitting the yarn 103 of the mesh material 102 with hydrophilic yarns or treating the mesh topical with hydrophilic chemicals.

When worn in conjunction with protective clothing and equipment, the thermoregulatory impact resistant material 100 of the present invention uniquely assists the body in regulating its temperature. In fact, it is well known that those individuals who are required to wear clothing or equipment to protect against such hazards as chemical agents, gases, fire, ballistics, impact from balls and from other players etc., are particularly at risk for hyperthermia. Any clothing or equipment which limits air flow to the surface of the skin negatively affects the body's thermoregulatory system and will cause internal body temperature to rise. Protective clothing and equipment generally lies directly on the skin and is not normally air permeable. Without the skin being exposed to the air, evaporative cooling—the body's most critical heat regulation mechanism—is rendered useless. In fact, continued and more intense attempts by the body to sweat without evaporation will simply escalate the thermal load and thus, compound the problem. In addition, in hot climates, or in professions such as firefighting, protective clothing and equipment absorb environmental heat and transfer this energy to the body by the process of conductivity, causing an additional stress on the body's already overloaded cooling system. All of this is further compounded by the fact that those wearing protective clothing and equipment often work under high levels of mental stress and intense physical exertion, and in environments with high ambient temperatures and direct exposure to the sun.

One exemplary embodiment of hyperthermia is the problem faced by American-style football players. Data from the Center for Disease Control (CDC) shows that the rate of time-loss to hyperthermia is 4.5 per 100,000 athlete exposures, a rate ten times higher than the average rate for all other sports. This is due in part to the fact that the helmet and pads football players wear cover only approximately 50 percent of their skin surfaces, and other clothing covers an additional 20 percent. Most disconcerting of all is the fact that between 1960 and 2009 there have been 123 documented cases of football players in the U.S. dying of illnesses directly related to hyperthermia, according to the records of the National Center for Catastrophic Injury Research.

Accordingly, heat related illness is a major issue that affects anyone who wears protective clothing/equipment. Its impact can range from creating impaired concentration to life threatening hyperthermia. The issues are such that many individuals choose not wear their protective clothing and/or equipment and face whatever the environmental hazards are and subject their bodies to heat distress, or in the case of firefighters, for example, remove themselves from firefighting. The net effect is that protective clothing and equipment has created some problems equally as dangerous to those it mitigates. Therefore, any technology that can reduce the heat burden would be a force multiplier for any affected organization or agency.

To combat the above drawbacks, the impact resistant material 100 of the present invention uniquely assists the body in regulating its temperature through four separate and independent processes.

Firstly, the thermoregulatory impact resistance material 100 of the present invention can be used as a wearable article 101 having a mesh material 102 with a base layer fabric 107 worn next to skin. The thermoregulatory impact resistance material 100 of the present invention elevates any protective clothing or equipment off the skin of the wearer permitting a space for air flow. As previously stated, most protective clothing and equipment lies directly on the skin and therefore blocks exposure to air which is essential for evaporative cooling to take place. The thermoregulatory impact resistance material 100 of the present invention dramatically increases the body's ability to use evaporative cooling by creating this “stand off” or gap between the protective clothing and equipment. The amount of air space between the skin and the protective clothing and equipment can be controlled in the knitting process of the mesh material 102 used in the present invention. Depending on the size of the air space desired, both the thickness (height), and the openness of the weave of the mesh material 102 can be controlled in knitting.

Secondly, as the body moves (i.e., running, catching a ball, etc.), it creates a “bellows” effect forcing air between the protective clothing and equipment and the thermoregulatory impact resistant material 100. The greater the air flow over the thermoregulatory impact resistant material 100, the more effective the evaporative cooling. This is perhaps most dramatically experienced by anyone wearing the mesh material 102 in a wearable article 101 under protective clothing and equipment, riding in an open air vehicle, motorcycle, boat or aircraft. In these cases, air flows over the thermoregulatory impact resistant material 100, and hence evaporative cooling, is greatly enhanced by the speed of the vehicle or craft moving through the air.

Thirdly, the thermoregulatory impact resistance material 100 of the present invention greatly increases the surface area on which evaporative cooling takes place. As previously stated, a one square inch of mesh material 102 has hundreds of yarns 103 passing through it in a very open weave which increases the exposure of the perspiration generated from one square inch of skin by many fold. As perspiration is wicked off the skin by the base layer fabric 107 and is absorbed into the yarns 103 of the mesh material 102, it is free for evaporation and hence, cooling. When the mesh material 102 used in the present invention is knitted from hydrophilic yarns, and/or treated with topical hydrophilic coatings, the wicking capability of the thermoregulatory impact resistance material 100 is further enhanced.

Fourthly, heat mitigation is accomplished via the thermoregulatory impact resistant material's ability to insulate the body from heat stored in the protective clothing and equipment. Such material when left in direct exposure to the sun and/or high ambient heat will absorb and store the heat energy. One example of this ability is ceramic and metal ballistic plates worn with soft body armor. They become like batteries storing the energy of the sun when exposed thereto. When that protective clothing or equipment lies directly on the skin, or on thin fabric, it transfers that heat via conductivity directly to the wearer.

However, when the thermoregulatory impact resistance material 100 of the present invention is worn beneath the protective clothing or equipment, the open air mesh material 102 provides an excellent insulating barrier inhibiting the transfer of the heat energy. The reason being is that heat energy travels efficiently through solids, particularly metals, but not through air. The air spaces in the mesh material 102 provide insulation and stop the conductive heat transfer from the protective clothing and equipment to the wearer. The insulation value of the mesh material 102 is a function of the thickness and openness of the mesh material's 102 weave and can be specified in the knitting process.

Hyperthermia is not the only issue that can be addressed by the unique features of the thermoregulatory impact resistant material 100 of the present invention. The present invention has not only the capacity to assist the body in maintaining a balanced heat load when subjected to excessive heat, but also when it is exposed to extremely low temperatures—in other words, when the body is in danger of becoming hypothermic. The very same insulation property of the thermoregulatory impact resistant material 100 of the present invention that protects the body against the conductive transfer of heat energy from protective clothing and equipment insulates the body from the loss of heat in cold conditions as well.

In cold conditions, the body stops perspiration and this decreases the heat loss due to evaporative cooling of the skin. The body will also try to increase the metabolic heat input to warm the body through involuntary shivering. The harmful effects of cold exposure are mediated by the balance between heat production and heat loss. There is a close relationship between muscle performance and muscle temperature - as temperature decreases, so does performance. For example, muscle strength is impaired and slower reaction times have been shown under cold conditions. In a cold environment the body utilizes vasoconstriction to reduce blood flow to the skin, skin temperature and heat dissipation. If the body temperature drops below that required for normal metabolism and bodily functions, a state of hypothermia exists. In humans, this is usually due to excessive exposure to cold air or water.

In the present invention, the transfer of moisture from the skin to the mesh material 102 of the thermoregulatory impact resistant material 100, in cold weather conditions, prevents the body from chilling as it cools down from exertion and exercise. Commonly referred to as the “refrigeration effect”, it is a real danger for anyone in a cold weather environment who generates sufficient heat energy to sweat during an activity, but once they stop, they are left wet from perspiration and lose heat rapidly. By transferring the perspiration away from the skin to the mesh material 102, the skin is not subjected to chilling events of cold moisture and hence remains warmer.

However, the thermoregulatory impact resistant material 100 of the present invention can help prevent hypothermia for athletes and for other cold weather users. The open air mesh material 102 used in the thermoregulatory impact resistant material 100 of the present invention provides a “stand off”or gap from the outside environment and the skin. Exemplary embodiments of the present invention's insulation properties include wearing the invention as a primary layer beneath outer wear in cold climates. In particular, in one exemplary embodiment, the thermoregulatory impact resistant material 100 can be worn under a dry suit when diving in cold water. In this example, air in the mesh material 102 has excellent insulation value and eliminates conductive heat loss from the body to the surrounding water.

In one embodiment, the thermoregulatory impact resistant material 100 of the present invention may have cold or heat chemical or electric packs attached to it for increased heating or cooling properties.

In one embodiment of the present invention, the mesh material 102 of the present invention provides impact resistance. In fact, one of the major reasons for wearing either protective clothing or equipment is to prevent injury to the body from impact of an outside force. The source of impact may be ballistic, a ball, or puck, the body of another person, animal or vehicle, an explosion, the “roost” (dirt and debris) kicked up by a dirt bike, or a fall etc. The protective clothing or equipment may be sufficient to provide a level of protection to prevent fatal injury but may still result in the wearer being hurt (i.e., ballistic plate may physically capture the bullet but the energy maybe still sufficient to cause bodily injury via backface deformation). In sports, for example, football pads may prevent broken bones but may still result in the player developing hematomas from the impact of the collision.

However, the unique three-dimensional nature of the mesh material 102 used in the thermoregulatory impact resistant material 100 of the present invention is at the heart of the energy absorptive capabilities of the invention. The thickness and density of the thermoregulatory impact resistant material 100 can be modified (i.e., distance between layers 104, tightness, thickness or openness of weave of fabric, tightness, thickness or openness of spacer or pile yarn 105 between layers 104, etc.), to precisely achieve the desired degree of energy absorption and dissipation. The highly flexible nature of the mesh material 102 gives it the ability to be worn over any area of the body; even those requiring the most movement and flexibility, such as joints.

In one embodiment, the thermoregulatory impact resistant material 100 of the present invention alone provides sufficient energy absorption without wearing protective clothing or equipment over it. Furthermore, if necessary, the thermoregulatory impact resistant material 100 can have plates or pads directly attached to it to increase its energy absorbing capabilities. Such pads or panels may be made from any number of materials including plastics, synthetics, metals or ceramics.

The amount of energy the thermoregulatory impact resistant material 100 of the present invention can absorb can be scientifically quantified in a laboratory setting. For example, one embodiment of the thermoregulatory impact resistant material 100, when worn under 3A body armor, had the net effect of reducing the backface deformation caused by a bullet striking the body armor by almost 30% over wearing the body armor alone.

In one embodiment, the thermoregulatory impact resistant 100 material of the present invention provides pressure resistance to the wearer. There are numerous sport and military pursuits, among others, that result in gear and clothing being compressed against the body. They include, among others, carrying a backpack or rucksack, wearing tactical body armor and equipment, and wearing protective clothing and equipment. These items create pressure points that cause friction and can develop into blisters on the wearer.

However, the compression resistant nature of the mesh material 102 of the thermoregulatory impact resistant material 100 of the present invention helps mitigate these pressure points and make the load more comfortable. In one exemplary embodiment, a full body suit of thermoregulatory impact resistant material 100 can be worn under a dry suit to help prevent “suit squeeze” caused by the pressure of the water as a diver descends in a dry suit. Rather than the dry suit being forced into the skin, it is absorbed in the mesh material 102 of the present invention. In other exemplary embodiments, individuals who must be seated or lay prone for extended periods of time would benefit from wearing the invention to prevent soreness. In exemplary medical applications, individuals with decubitus ulcers or individuals confined to lying in a bed, or seated in a wheel chair for extended periods of time, would also benefit. Other persons who could benefit from the present invention's capacity to absorb pressure include, but are not limited to: soldiers, tactical law enforcement officers, fire fighters who carry air packs, backpackers, race car drivers, military pilots and divers, etc. Thus, the mesh material 102 of the present invention absorbs pressure and provides the skin with more air flow, providing an advantage in a myriad of situations.

In one embodiment, the thermoregulatory impact resistant material 100 of the present invention can be used as the base of a platform technology. There are a number of existing and dozens of emerging technologies that would benefit from using the present invention as a base platform, thus, making it a part of a “system of systems”. The one common denominator of these technologies is that all the devices must be worn by the human body for optimal effectiveness. Some of these technologies include, but are not limited to, monitoring body functions using sensors placed in close proximity to the skin (i.e., to obtain any and all feedback on the physiology (heart, respiratory rate, temperature, etc.), for performance of the human body including those being developed (i.e., to conduct battlefield triage); personal active heating and cooling devices which require micro tubes and wires to be worn over most of the body; communications antennas which require long wires, personal floatation devices; and technologies used to reduce human heat signature. The unique open weave of the mesh material 102 used in the present invention is such that items 108 (see FIG. 4), such as sensors, wires, or tubes, can be woven in between the two layers 104 or surfaces of the mesh 102 without causing any discomfort to the wearer. The wires, tubes, and sensors can be added during or after knitting of the mesh material 102. Thus, the present invention is such that it creates a physically comfortable, wearable platform for these technologies, which are of different shapes and materials.

In one embodiment, the base layer fabric 107 and mesh yarn 103 can be manufactured in any color or colors. For example, the colors may include the specific color combinations of teams and organizations. The base layer fabric 107 and mesh material 102 may also be embellished with licensed logos and trademarks of teams and organizations. The unique structure of the mesh panels 106 permits knitting the mesh material 102 in multiple colors. For example, it could be “blue and gold” or “red and white” or “black, red and white” depending on the color of the yarns used in the knitting process.

Thus, the function and versatility of the thermoregulatory impact resistant material 100 of the present invention provides benefits to a wide array of individuals and occupations, including those who will utilize the present invention conjunction with protective clothing and equipment, such as: soldiers; law enforcement officers; fire fighters; any professional who wears a HAZMAT suit; bomb disposal personnel; any person who wears a pressurized suit (i.e., astronauts, high altitude pilots, divers); any athlete or person working or playing in a hot environment, especially those in arid environments, including football players, lacrosse players, hockey players, baseball players, rugby players; motor cross enthusiasts; automobile or motorcycle racing drivers; rodeo and equestrian riders; skateboarders; snow sport enthusiasts (i.e., skiing, snowboarding, snowmobiling, luge, and bob sled); backpackers; umpires; martial artists; and paint ball and air soft enthusiasts, etc.

Finally, as noted above, there are a number of technologies where the thermoregulatory impact resistant material 100 is a base platform thereof, and which require close proximity to the body for optimal effectiveness.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A protective material, comprising:
a mesh material including a plurality of layers of woven yarn, said plurality of layers being connected by a spacer yarn; and
a base material connected to said mesh material on one surface of said mesh material, and connected to one of said plurality of layers;
wherein said mesh material is provided in a three-dimensional form as a wearable article, and provides thermal regulation and resistance to impact and pressure for a user.

2. The protective material of claim 1, wherein said mesh material is warp knitted double-faced fabric.

3. The protective material of claim 1, wherein said yarn is knitted and is comprised of at least one of nylon, polyester, rayon, modacrylic, PPS (polyphenylene sulfide), or aramids, or any combination thereof.

4. The protective material of claim 3, wherein said yarn is one of fire resistant, hydrophobic, hydrophilic, or a combination thereof.

5. The protective material of claim 1, wherein said plurality of layers has an overall pattern.

6. The protective material of claim 1, wherein said spacer yarn is one of a monofilament yarn or a multifilament yarn.

7. The protective material of claim 3, wherein said knitted yarn of said mesh material is woven to provide properties of at least one of compression or impact resistance, recovery, breathability, moisture transfer capabilities, or thermal regulation; and
wherein said properties of said mesh material can be varied or controlled by an openness, thickness, or tightness of said weave of said yarn, or a distance between said plurality of layers.

8. The protective material of claim 7, wherein said mesh material is treated with chemicals to provide at least one of fire resistance, antimicrobial properties, antistatic properties, or abrasion resistance, or hydrophobic or hydrophilic properties.

9. The protective material of claim 1, wherein said base material is circular or tubular knitted.

10. The protective material of claim 1, wherein said mesh material is shaped as a panel.

11. The protective material of claim 1, wherein said wearable article is at least one of a body suit, shirt, top, shorts, pants, undergarment, sports wear, headwear, protective gear, outerwear, or accessory.

12. The protective material of claim 1, wherein a weight of said base material is approximately 3 to 6 ounces per yard for said wearable article designed for cooling purposes, and from 8 to 12 ounces for said wearable article designed for insulator purposes.

13. The protective material of claim 1, wherein said mesh material one of completely covers said base material, or does not completely cover said base material.

14. The protective material of claim 3, wherein said base material is connected to said one of said plurality of layers of said mesh material on said surface of said mesh material at an outer perimeter thereof using a binding material, said binding material which connects to said base material using an attachment mechanism.

15. The protective material of claim 1, wherein said base material is comprised of manmade or natural fibers and yarns including at least one of cotton, wool, nylon, polyester, rayon, modacrylic, aramid, or a blend thereof.

16. The protective material of claim 1, wherein said base material has properties including at least one of moisture vapor transfer, clo value, stretch, modularity, antimicrobial properties, antistatic properties, fire resistance, sun protective factor (SPF), or abrasion resistance.

17. The protective material of claim 1, wherein said base material is a synthetic material including elastane.

18. The protective material of claim 1, wherein said mesh material is worn in a wearable article in conjunction with protective clothing and equipment.

19. The protective material of claim 1, further comprising at least one of cold or heat chemical or electric packs, or plates or pads, attached to said mesh material to increase heating or cooling properties;
wherein said plates or pads are comprised of at least one of plastics, synthetics, metals or ceramics.

20. The protective material of claim 1, wherein said mesh material is a base platform for technologies which include a plurality of devices, said plurality of devices including sensors, antennas, wires, or tubes, used in a plurality of applications.

21. The protective material of claim 20, wherein at least one of said plurality of devices is disposed in said mesh material between said plurality of layers.

22. The protective material of claim 1, wherein said base material and said mesh material are of any color.

23. The protective material of claim 1, wherein said double-faced fabric includes one of a same or a different design and/or yarn content on each face of said double faces.

24. The protective material of claim 1, wherein said mesh material is one of stable or provides stretch in one or more directions.
